(19) United States
(12) Patent Application Publication
(10) Pub. No.: US 2009/0063889 A1
(43) Pub. Date: Mar. 5, 2009

(54) ALIGNING DATA ON PARALLEL TRANSMISSION LINES

(76) Inventors: Faisal DADA, Kanata (CA); Tarik Rostum, Kanata (CA); Marius Lucian Draghia, Carp (CA); Eugen Vlaicu, Kanata (CA)

Correspondence Address: Teitelbaum & MacLean, 280 Sunnyside Avenue, Ottawa, ON, K1S 0R8, CA

(21) Appl. No.: 12/126,042

(22) Filed: May 23, 2008

Related U.S. Application Data
(60) Provisional application No. 60/970,060, filed on Sep. 5, 2007.

(51) Int. Cl. G06F 1/24

(52) U.S. Cl. 713/503

(57) ABSTRACT

The lane skew alignment device of the present invention facilitates the use of the SFI-5 standard interface in an FPGA without the need to rely on feedback signals from a remote device. The delay between lanes is determined using a D-Flip Flop or other type of phase comparator. To minimize the components needed to physically implement the solution a cross-point switch is used to select one of the parallel lanes at a time to be compared to a reference lane, over which the same test signal is transmitted.

### CROSS-REFERENCE TO RELATED APPLICATIONS

The present invention claims priority from U.S. Patent Application No. 60/970,060 filed Sep. 5, 2007, which is incorporated herein by reference.

### TECHNICAL FIELD

The present invention relates to reducing the skew between streams of data pulses in parallel transmission lines, and in particular to aligning parallel data streams that are transmitted using the SFI-5 protocol.

### BACKGROUND OF THE INVENTION

A typical line interface of a communication system with a 40 Gb/s optical links is expected to consist of three separate devices: an optical module containing a serializer/deserializer (SERDES) component, a forward error correction (FEC), and a Framer. The interconnection between these devices will be electrical, in which the maximum data rate per signal is less than the optical data rate, whereby a multi-bit bus is required.

The standard SERDES Framer Interface (SFI-5) protocol, which has been published by the OIF and is incorporated herein by reference, clearly specifies how to perform de-skew functioning when multiple parallel lanes of data are received in a receiver. Other related methods are disclosed in United States Patent Publication No. 2006/00129869, entitled Data De-Skew Method And System, published Jun. 15, 2006 in the name of Hendrickson et al; and U.S. Pat. No. 6,618,395, entitled Physical Coding Sub-Layer For Transmission Of Data Over Multi-Channel Media, issued Sep. 9, 2003 to Kimmitt et al; and U.S. Pat. No. 7,287,176 entitled Apparatus, Method And Storage Medium For Carrying Out Deskew Among Multiple Lanes For Use In Division Transmission Of Large-Capacity Data, issued Oct. 23, 2007 in the name of Kim et al.

The SFI-5 protocol, which is used for many devices, e.g. framers, forward error correction processors and optics modules, requires that high speed data be transmitted striped over many lanes. The skew requirement between these lanes is quite stringent, i.e. the data must be transmitted on each lane within 2UI (universal interval bit times, e.g. 1 UI=1 bit=400 pico sec) of each other at the output of the transmitter. Unfortunately, conventional SERDES devices available in current field programmable gate arrays (FPGA) or other commodity silicon devices can't fully meet the skew requirement between the lanes.

An example of a SERDES Framer Interface Level 5 (SFI-5) standard support is the Stratix® II GX FPGAs made by Altera Corporation with embedded transceivers, providing a 40 Gb/s to 50 Gb/s interface for high-performance optical communications applications. The SFI-5 specification is a chip-to-chip standard that ensures interoperability between forward-error correction (FEC) and the framer, as well as from optical transponder devices. The Stratix II GX FPGAs feature up to 20 high-speed serial transceiver channels that can operate at data rates between 60 Mbps and 6.375 Gbps, satisfying SFI-5 interface requirements.

The SFI-5 Optical Internetworking Forum (OIF) specification was developed to provide an interface between the network processing devices and the optical transponder to enable higher bandwidths. The SFI-5 standard addresses network transport formats including OC-768, STM256, and OTN OTU-3. Unfortunately, the de-skew signal generating circuit and the de-skew circuit, which performs de-skew processing based on the generated de-skew signal is large, whereby power consumption and circuit size are increased.

Featuring up to 20 transceiver channels operating from 600 Mb/s to 6.375 Gb/s, Altera's Stratix II GX FPGAs offer a solution to applications that require multi-gigabit serial I/O. Stratix II GX devices offer a complete solution supporting many serial protocols, including SerialLite II, XAUI, SONET/SDH, Gigabit Ethernet, Fibre Channel, Serial RapidIO®, PCI Express, SMPTE 292M and SFI-5.

In the exemplary Stratix-II GX FPGA, a core clock is isolated from an internal GX2 transmit clock using a phase compensation FIFO memory. An internal transmit clock for each lane is frequency locked to the core clock, but the phases of each internal transmit clock will not be aligned. Each lane has its own phase compensation FIFO, which cannot be bypassed. Unfortunately, there is no phase relationship between the internal transmit clock of each lane and the core clock. The skew problem can be avoided between lanes within one transmitter group of four lanes (QUAD) as the lanes within one quad can be bonded; however, lanes between QUADs cannot be bonded.

The core clock is used as a source for data to be written into all seventeen lanes for the SFI-5 application. The data from the core clock is written into the phase compensation FIFO for each lane. The internal transmit clock for each lane is used to read the phase compensation FIFO for each lane; however, there is no phase relationship between the clocks used to read from the phase compensation FIFO of each lane. Moreover, the FIFOs may all have different fill levels, as a result of each phase compensation FIFO coming out of reset at a different time. The fill levels will reach a steady state after reset and will not change during regular operation. The levels in the phase compensation FIFOs may be off by up to 16 bits, and possibly up to 32 bits depending on the implementation in the FPGA. A 16 bit delay in the FIFO corresponds to a 16 UI difference on the line.

Skew between lanes may also be inserted by the serialization process of the parallel data. The point in time where data is loaded into each serializer is not synchronized across all lanes. The only known relationship between serialized data across all lanes is that 16-bits of parallel data are loaded into the serializer on one of the edges of the fast transmit clock within the slow system clock. If the data on one lane is loaded on the first positive edge of the fast clock after the positive edge of the slow clock and on another lane the data is loaded on the last positive edge of the fast clock before the positive edge of the slow clock, a difference of 16 UI will occur on the line.

Accounting for the addition of skews because of the phase compensation FIFOs and the serialization of the data at least 32 bits of skew could exist between the fastest lane and the slowest lane, and up to 48 bits of skew if the phase compensation FIFOs cause greater skew.

U.S. Pat. No. 6,952,789 entitled System and Method for Synchronizing a Selected Master Circuit with a Slave Circuit by Receiving and Forwarding a Control Signal Between the Circuits and Operating the Circuits Based on their Received Control Signal, issued to LSI Logic Corporation, deals with aligning data between various master and slave devices.

U.S. Pat. No. 7,020,728 entitled Programmable Serial Interface, issued to Cypress Semiconductor relates to a serial interface device including a die with a communication channel that converts serial data signal to parallel data signal, in which the die is coupled to routing channels to exchange parallel data signal with logic block clusters.

United States Patent Publication No. 2006/0156083 entitled Method of Compensating for a Byte Skew of PCI Express and PCI Express Physical Layer Receiver For The Same, published in the name of Samsung, deals with using alignment characters on the receiver and removing certain bytes to align their data stream.

United States Patent Application No. 2008/0031312 entitled Skew-Correcting Apparatus Using Iterative Approach, published in the name of Avalon Microelectronics on Feb. 7, 2008 requires feedback from a receiver to align the lanes.

An object of the present invention is to overcome the shortcomings of the prior art by providing a way to implement the SFI-5 protocol in a commodity chip (FPGA) rather than an ASIC.

Whereas conventional chip designers have devised ways to align the channels on the receiver or to use feedback from the receiver, the present invention relates to aligning the output of the transmitter, which is needed for the standard protocol to work without requiring a receiver.

The present invention sends a known pattern on each lane and then compares the lanes to a reference lane, e.g. any one of the lanes previously selected. When the patterns are matched on each lane, the lanes are aligned and the skew inserted by each SERDES is known. After determining the skew between the SERDES's the data is adjusted, so that the skew is corrected and the transmitted data is completely aligned between the lanes. The present invention includes a combination of on-board (PCB) components and specialized logic in the FPGA.

### SUMMARY OF THE INVENTION

Accordingly, the present invention relates to a method for de-skewing a plurality of parallel lanes in a parallel data transmission system, comprising the steps of:

a) selecting a first of the parallel lanes as a reference lane;

b) transmitting a test signal on the reference lane and on a second of the parallel lanes;

c) determining whether the test signal on the second of the parallel lanes is substantially in phase with the test signal on the reference lane;

d) if the test signal on the second of the parallel lanes is not in phase within the predetermined interval with the test signal on the reference lane, then determining an amount of phase adjustment required to bring the phase of the test signal on the second parallel lane substantially in phase within the predetermined interval with the test signal on the reference lane;

e) repeating steps b) to d) for all of the parallel lanes;

f) transmitting data signals over the plurality of parallel lanes, wherein the phase of each of the parallel lanes is individually adjusted in accordance with the amount of phase adjustment required to bring the phase of the test signal on the respective parallel lane substantially in phase within the predetermined interval with the test signal on the reference lane.

Another aspect of the present invention relates to a lane skew alignment device for receiving a plurality of parallel multi-bit signals on a plurality of multi-bit lanes from an SFI encoder and for adjusting a phase of each of a plurality of parallel multi-bit signals for input to a SERDES, whereby all of the multi-bit signals are substantially in phase within a predetermined interval, comprising:

a control interface for selecting a first of the multi-bit parallel lanes as a reference lane, and for consecutively selecting remaining multi-bit parallel lanes for comparison thereto;

a pattern generator for transmitting a test signal on the reference lane and on the selected parallel lane;

a phase comparator for determining whether the test signal on the selected parallel lane is substantially in phase with the test signal on the reference lane; and

a lane shifter for shifting the selected parallel lane until the test signal on the selected parallel lane is substantially in phase with the test signal on the reference lane to determine an amount of phase adjustment required to bring the phase of the test signal on each of the parallel lanes substantially in phase within the predetermined interval with the test signal on the reference lane;

whereby the control interface adjusts data input to each lane until all the lanes are bit aligned within the predetermined interval at the output of the SERDES.

### BRIEF DESCRIPTION OF THE DRAWINGS

The invention will be described in greater detail with reference to the accompanying drawings which represent preferred embodiments thereof, wherein:

FIG. 1 is a schematic representation of an FPGA skew correcting circuit in accordance with the present invention;

FIG. 2 is a schematic representation of an FPGA in accordance with the present invention;

FIG. 3 illustrates a sequence of clock patterns for comparison to a reference clock pattern;

FIG. 4 illustrates the output on a lane before and after skew adjustments;

FIG. 5 is a schematic representation of a lane skew alignment system of the FPGA of FIG. 2;

FIG. 6 is a flowchart of the de-skewing process of the present invention; and

FIG. 7 illustrates test signals on test lane N and reference lane 0 when out-of-phase and when in-phase, and the corresponding feedback alignment signal.

### DETAILED DESCRIPTION

To be successful in delivering a fully encapsulated solution that is not dependent on signals from other devices, e.g. receivers, the present invention includes components placed on a printed circuit board (PCB) 1 between an FPGA 2 and an SFI-5 interface 3. The illustrated embodiment is one example of the components that may be place on the PCB 1 to implement the solution; however, other configurations using multiple components may be used to provide the same function.

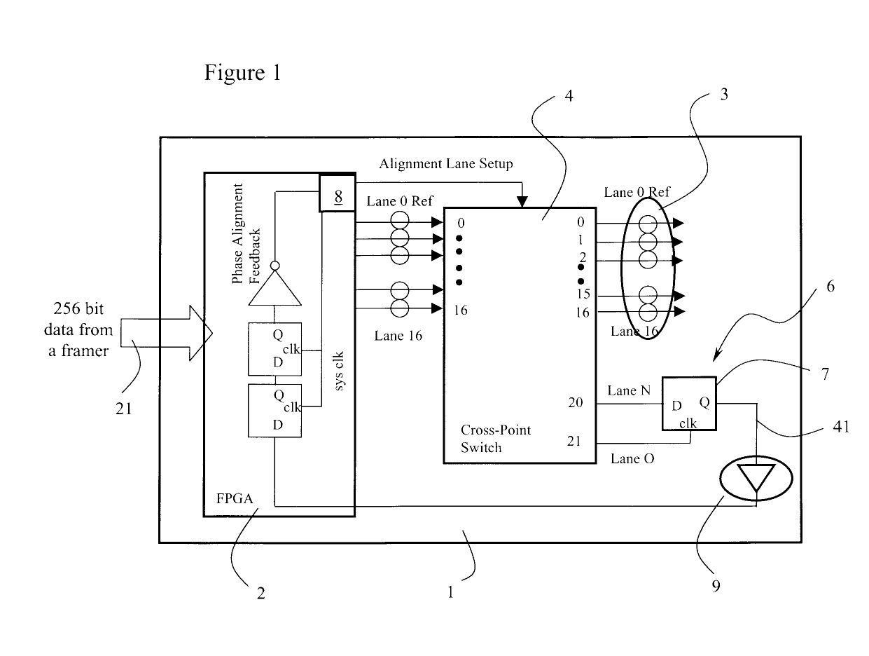

With reference to FIG. 1, a cross-point switch 4 and a phase comparator 6, based on a D Flip Flop 7, are mounted on the PCB 1 between the FPGA 2 and an SFI-5 interface 3. A plurality of input lanes, e.g. 0 to 16, of the cross-point switch 4 are routed from the FPGA 2, through the cross-point switch 4, directly to corresponding lanes, e.g. 0 through 16, of the SFI-5 interface 3. The plurality of lanes, e.g. seventeen, are made up of data bits 0 through 15 and a de-skew bit lane. A control interface 8 to the cross-point switch 4 selects a pair of lines that are output from the cross-point switch 4 and input to the phase comparator 6. Lane 0, or any one of the other lanes, is routed to output port 21 of the cross-point switch 4, and used as the reference signal that all other lanes are compared against in the alignment circuitry. The cross-point switch 4 reduces the number of phase comparators 6 needed to one, rather than requiring a plurality of phase comparators, thereby eliminating the board (PCB) layout issues that would be present if individual comparators and buffers were used for each phase comparison.. The control interface 8 sequentially selects and directs one of the input lanes 1 to 16 to Lane N, i.e. output port 20, to be the current lane that is compared with Lane 0 in the phase comparator 6. Accordingly, the phase comparator circuitry 6 is dynamically controlled and the same devices, e.g. the DFF 7, with a level translator 9 in the above example, can be used to align the phase of all SFI-5 lanes. The level translator 9 ensures that the output of the DFF 7 is always a good logic 0 or 1 even when there is meta-stability.

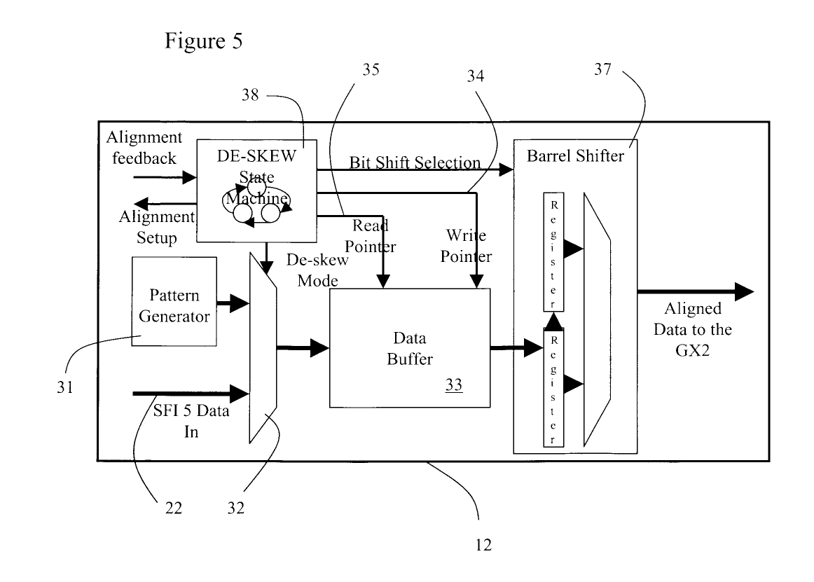

The D Flip Flop (DFF) 7 is used to implement the phase comparator 6, in which one lane, i.e. the reference lane—Lane 0, is used as the clock to the DFF 7 and the other lane, i.e. the multiplexed lane—Lane N, is used as the data input to the DFF 7. When the clock and data signals are aligned, the output of the DFF 7 will be assert to a logic level “1”. The output of the DFF 7 is fed back into the FPGA 2, where a state machine 38 (See FIG. 5) controls the alignment process.

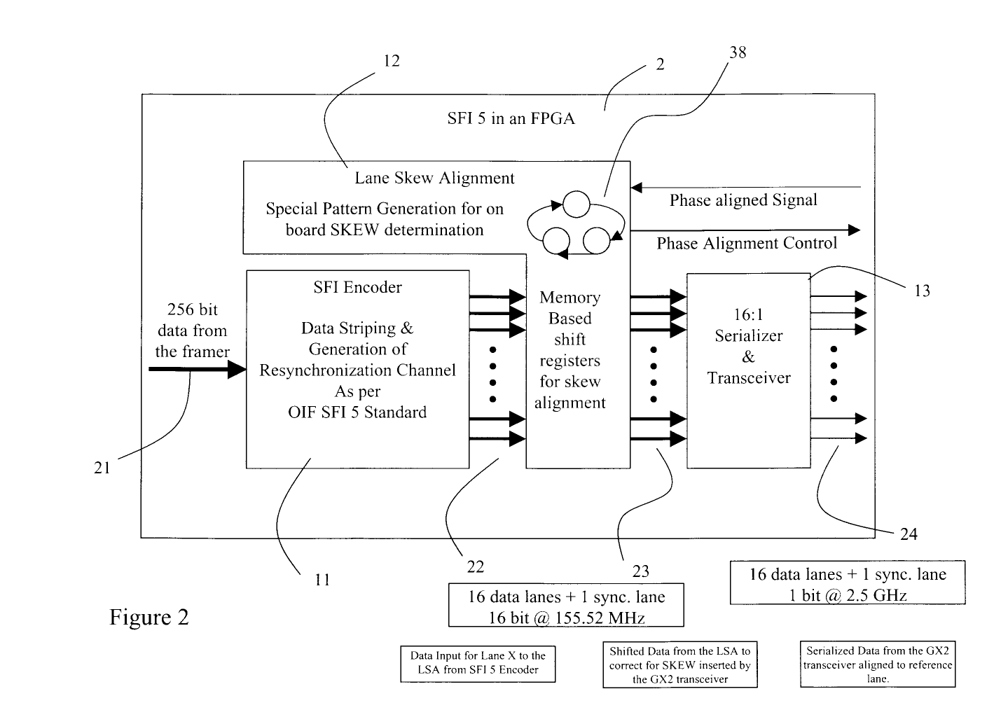

With reference to FIG. 2, the FPGA 2 comprises three major architectural blocks: a SFI-5 encoder 11, a lane skew alignment module 12, and a SERDES (serializer/deserializer) 13. The SFI-5 encoder 11 implements the SFI-5 transmit interface encoding as specified in the OIF SFI-5 standard. The SFI-5 encoder 11 accepts a data bus 21, usually a 256-bit parallel bus, but any bit width is acceptable, from the system side interface and creates a SFI-5 compliant de-skew channel, usually a sixteen-bit parallel bus 22. The data bus 22 and the de-skew channel are output from the encoder 11 and input to the lane skew alignment module 12.

The lane skew alignment module 12 shifts the sixteen transmit data channels 22, each of which are sixteen-bits wide at 155.52 MHz before serialization forming the 256-bit data bus, so that the skew on the PCB board 1 at the output of the FPGA 2 is no more than two UI with respect to the synchronization channel. The lane skew alignment module 12 is important because an FPGA implementation requires dynamic alignment of the SFI-5 output data, whereas an ASIC implementation would most likely not need the same dynamic alignment.

The third major block is the SERDES 13, a macro module readily available from FPGA vendors. The SERDES 13 receives a de-skewed parallel bus input 23, sixteen channels of sixteen bits at 155.52 MHz, and serializes the input into sixteen lanes 24 of one bit at 2.5 GHz, which combine to provide a signal at 40 Gb/s. Unfortunately, conventional SERDES macros available from FPGA vendors do not guarantee that the phase relationship between the input lanes 22 and the high speed output lanes 24 are within the required UI to be OIF SFI-5 compliant.

The lane skew alignment module 12 adjusts for the skew injected by the SERDES module 13. The lane skew alignment module 12 has a buffer for each lane of data, so that the read pointers 35 (see FIG. 5) can be adjusted into the buffers 33 to match the individual skew across each lane on the PCB board 1.

To accomplish the re-alignment the lane skew alignment module 12 inserts a clock like pattern with a known period on each output lane 22. The pattern is monitored on the PCB board 1 and when the pattern across all lanes is aligned, regular traffic is then allowed to be transmitted. During the period of skew alignment the output of the cross-point switch 4 towards the far-end SFI-5 receiver 3 is turned off.

Details on the pattern that is generated, how the alignment is done, and why the skew alignment is needed are found in the ensuing example.

Altera provides a SERDES and a transceiver in the Stratix2 GX® line of chips. The GX2 transceiver accepts data on an 8-bit or a 16-bit parallel interface and generates a single bit output at up to 6.125 Gb/s, i.e. 256-bits+16-bits are serialized to 16+1 lanes. In the SFI-5 application the highest lane bit rate defined is 3.125 Gb/s. To achieve 3.125 Gb/s the transceiver must be configured as either a 16-bit interface with a core clock speed of 195 MHz or an 8-bit interface with a core clock speed of 390 MHz. In pure SONET applications the data rate needs to be 2.488 Gb/s corresponding to core frequencies of 155.52 MHz/311.04 MHz with the 16-bit/8-bit interface. To minimize the core frequency and ease routing/timing closure, the GX2 transceiver should be configured in 16-bit mode.

The objective of the LSA module 12 is to adjust the data input to the SERDES 13 so that the output of all the lanes 24 is within three UI or less and ideally two UI or less of each other. As noted above, the SERDES macro can insert many (>32) UI of skew between channels, which does not change until the chip is reset, i.e. it is static during SFI-5 operation. The LSA 12 adjusts for the static skew by adjusting the data input to each lane of the SERDES 13. The data input to each lane is adjusted until all the lanes are bit aligned at the output of the SERDES 13.

To align all the lanes, the LSA 12 uses lane 0 as a reference lane, whereby the skew on all the other lanes 1 to 16 is adjusted to make them align to lane 0. The first task is to determine each lane's skew with respect to the reference lane 0. To determine the skew between two lanes a know pattern must be sent on both lanes.

The LSA 12 sends out a clock pattern on each lane 1 to 16, which is a 50% duty cycle clock with a period of N bits. The period should be greater than four times the maximum skew, e.g. a period of 256 bits or more. The pattern on each lane is compared to the reference lane, lane 0, on the PCB board 1 in a round robin manner. Other types of pattern like pulses could be used. A pattern of N bits may be used, where N is not greater than 4 times the max skew. In this case the search would have to be done both in the forward and backward direction. The greater than 4 helps simplify the design but is not mandatory.

The pattern on the reference lane, lane 0, is shifted ahead by 64 bits, which assures that the data on all the other lanes is now behind the data on lane 0; accordingly, the search only needs to be done in one direction. Other methods like delaying the reference lane or manipulating all the data lanes or not touching either lane, but searching in both directions can be used as well.

The pattern on the selected data lane being compared is then slowly moved ahead, and after every move of the pattern a compare result is received, i.e. a finite period of time after changing the pattern, if a phase match is not found the pattern on the lane is shifted ahead by 1 bit. This is repeated until a phase match is found or until a total of 128 shifts have been performed. By checking 128 bits of search space a pattern that was within 64 bits in each direction of the initial lane 0 must be aligned. If a phase match is found for the lane in question (LANE X) within N shifts the skew on the lane can be defined as shown below. If a phase match cannot be found on LANE X within 128 bit shifts an error is declared and LANE X cannot be de-skewed using the 256 bit pattern.

IF (N<=64)

LANE X is 64—N bits ahead of the reference lane (reference lane was shifted by 64 bits).

ELSE IF (N<=128)

LANE X is N—64 bits behind the reference lane.

ELSE

LANE X CANNOT BE DE-SKEWED

This procedure is repeated 16 times, once for each lane numbered 1-16 and the phase relationship is stored in memory in the LSA module 12 for each lane.

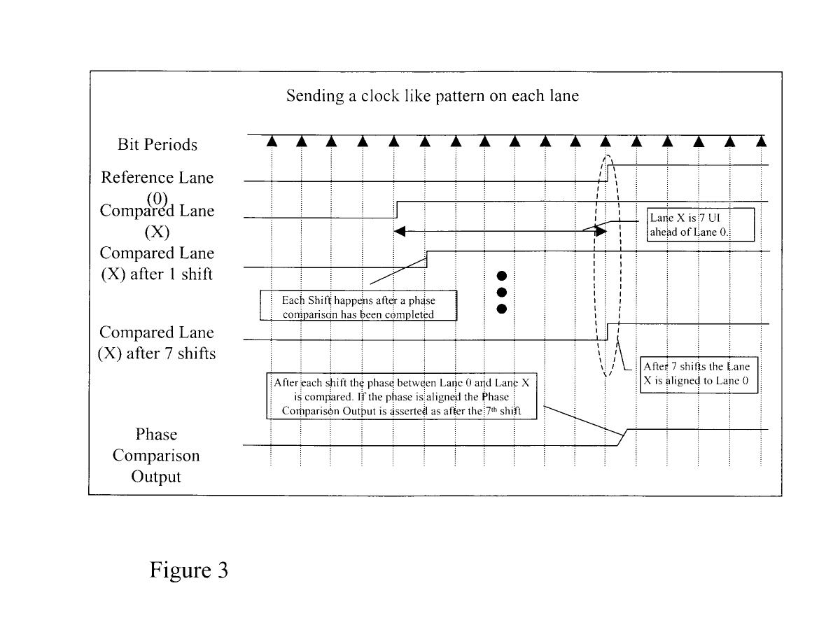

FIG. 3 illustrates the relative skew between the reference lane 0 and lane X. The reference lane 0 shown is already shifted 64 clocks ahead. After each phase comparison, lane X is shifted by 1 UI. In the illustrated example, after seven shifts the reference lane 0 and lane X are aligned. This process is repeated for each lane 1 to 16.

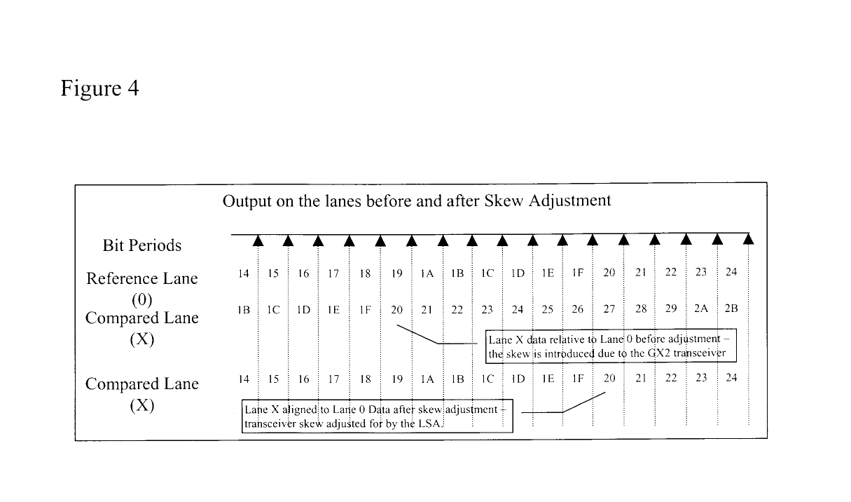

Once the relative skews for each lane have been determined, e.g. when the device is turned on or reset, the data for each lane is either delayed or pulled ahead by the number of bits the lane in question is ahead or behind the reference lane. The adjustment ensures that the data going to the transceiver input is aligned such that the output of the SERDES 12 are bit aligned as shown in FIG. 4.

In FIG. 4 the bits on each lane are numbered using a two-digit numbering scheme. Each bit is denoted by a number XY. The X (represented in hexadecimal) is the internal data transaction to the LSA module 12 from the SFI-5 encoder 11. Each transaction is a 272-bit word which is comprised of 17, 16 bit words, one for each lane. The Y (represented in hexadecimal) is the actual bit position within that 16 bit word for each lane.

With reference to FIG. 5, the following is one method for implementing the LSA 12, which is a memory intensive design that attempts to use a minimal number of FPGA “logic elements”. FIG. 5 illustrates the implementation for only one lane; however, all of the lanes must be de-skewed before the SFI-5 can function properly.

A fixed pattern is required for the reference lane 0, as described previously. A pattern generator 31 is used to generate the aforementioned clock pattern with a period of at-least four times the amount of skew that needs to be corrected. The static skew introduced by the FPGA 2 can be up to forty-eight UI; accordingly, to compensate for forty-eight UI the pattern generator 31 is set to produce at least a 256 bit, 50% duty cycle, clock pattern, e.g. 128 1's followed by 128 0's.

To operate the LSA 12 in DE-SKEW MODE a multiplexer 32 must be configured to select the data from the pattern generator 31. To operate the LSA 12 in NORMAL MODE the multiplexer 32 is set to select the input data to the SFI-5 core 22. The output of the multiplexer 32 is sent to one 32×16-bit data buffer 33 per lane. Write pointers 34 and a read pointers 35 are maintained for each data buffer 33.

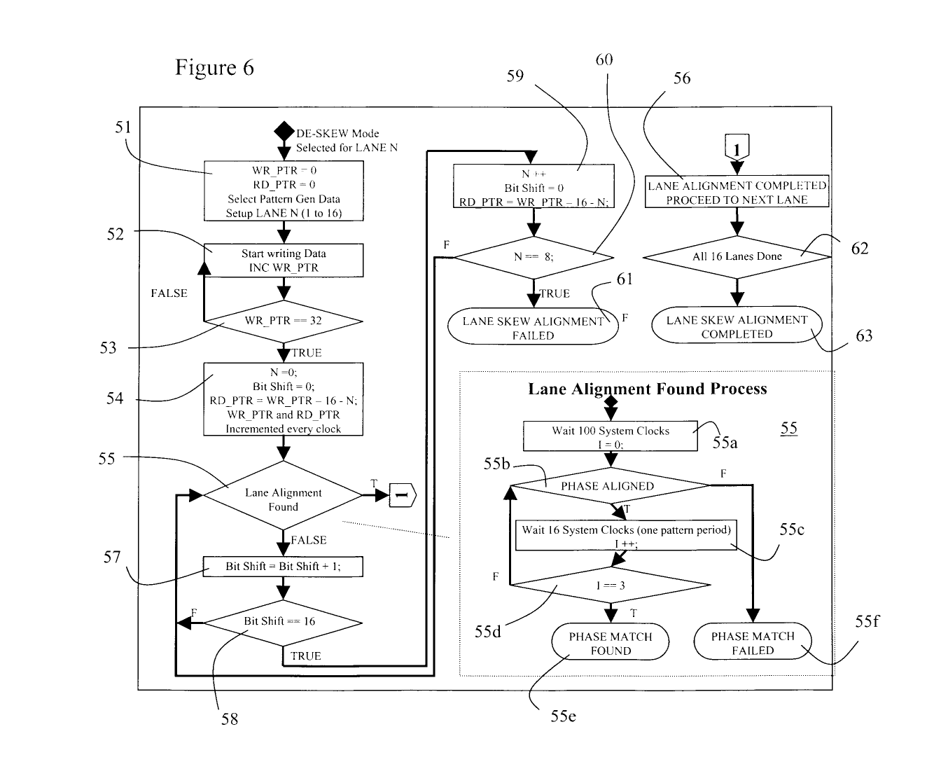

With reference to FIG. 6, when the LSA module 12 is configured in DE-SKEW MODE both the write and read pointers 34 and 35 are cleared (Box 51). The data from the pattern generator 31 is written into the buffer 33 (Box 52). When the write pointer 34 reaches thirty-two (Decision Box 53) the read pointer 35 is set to at least twenty for the reference lane 0 and sixteen for all the other lanes, and data is read out of the buffer 33. Accordingly, the reference lane is shifted ahead at least sixty-four bits with respect to all the other lanes, i.e. each pointer is sixteen bits. The read pointer 35 on all lanes other than the reference lane is sixteen clocks behind the write pointer 34 (Box 54). The output data from the buffer 33 is then sent to the SERDES 13 through a barrel shifter 37. With reference to magnified Box 55, the de-skew state machine 38 waits for 100 clocks (Box 55a) then compares an alignment feedback signal 41 from the on-board D Flip Flop 7 for the first lane (Decision Box 55b). When the alignment feedback signal 41 is asserted for forty-eight consecutive system clock periods, i.e. 3 pattern periods, (Boxes 55c and 55d) alignment is done (Box 55e or 56) otherwise alignment is not done (Box 55f).

Care must be taken with the alignment feedback signal 41, such that alignment should only be declared on the positive edge of the alignment feedback signal 41—a level high feedback signal does not necessarily mean that alignment is done. If the alignment is not done the barrel shifter 37 bit-shifts the data (Box 57). The alignment is re-checked and if it still does not match up, fourteen additional shifts are done using the barrel shifter 37 (Box 58). After fifteen shifts the read pointer 35 is advanced such that it is only fifteen clocks behind the write pointer 34 and the barrel shifter 37 is reset to have no bit shift, which implies a 16-bit shift from the original alignment (Box 59). The process is repeated until the alignment is done or until the read pointer 35 is only seven shifts behind the write pointer 34 (Decision Box 60). When the read pointer 35 on the first lane is only seven shifts behind the write pointer 34 a search has been performed for all the required 128 bits. If the alignment is not found in this search space an alignment error is declared (End 61). If the alignment is found within this search space the process is repeated (Decision Box 62) for all remaining lanes until all lanes are aligned (End 63).

Once the de-skew process is complete, i.e. all lanes have been de-skewed, a state machine 38 will enter a TRAINING PATTERN MODE, in which a “1010 . . . ” pattern is sent for a set period, e.g. 256 system clocks, to create a good bit density on the line. After this is done normal traffic flow may resume.

The previous sections describe how the FPGA 2 aligns the skew on the lanes based on a feedback from a phase comparator 6. The basic idea behind the phase comparator logic is that the reference lane, e.g. lane 0, is used as the clock for the D flip-flop 7. The selected signal from lane N, i.e. 1 to 16, is sent into the input of the D flip-flop 7. When the edges of the signals in lanes 0 and N are aligned, the output of the D flip-flop 7 transitions from a 1 to a 0, whereby the Phase Alignment Feedback signal 41 transitions from a 0 to 1. The Phase Alignment Feedback signal 41 is an inverted version of the output of the D Flip Flop 7.

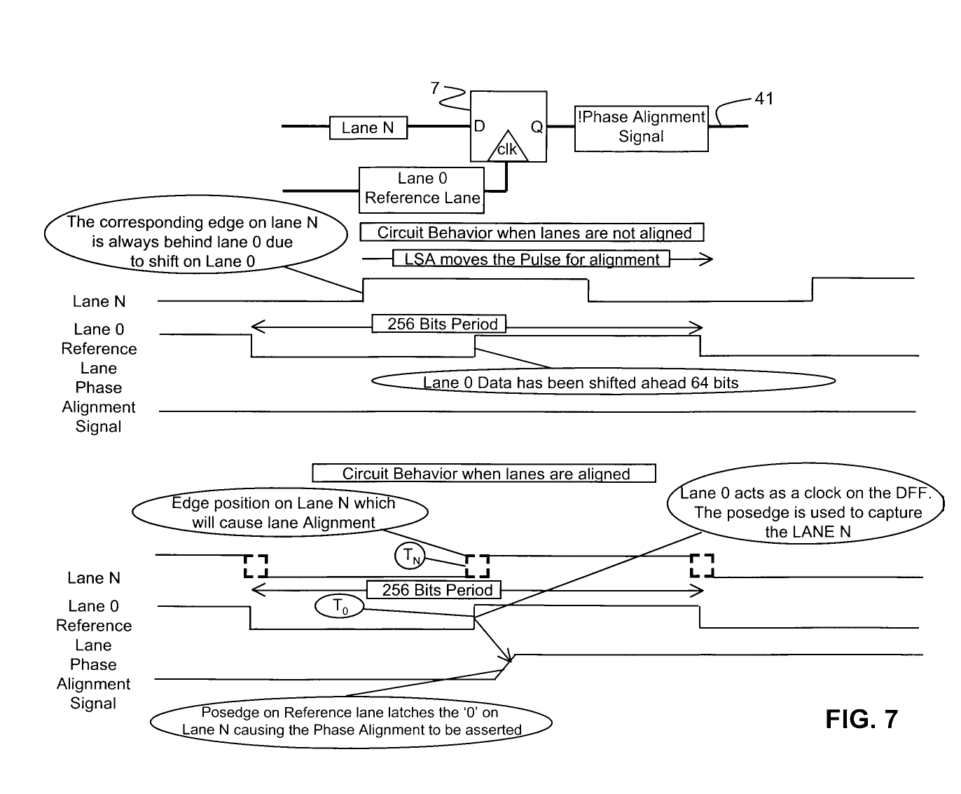

With reference to FIG. 7, a positive edge (posedge) of the Phase Alignment Feedback signal 41 represents the instance when the reference lane 0 and the lane N being compared have been de-skewed. The method defined in FIG. 6 will first assert the Phase Alignment feedback signal 41 whenever the pulse on lane N falls within the defined range, e.g. up to 3UI, preferably 2 UI, as shown in the cross-hatched area, around the positive edge of the lane 0 signal. On the positive edge of the Phase Alignment Feedback signal 41 the lanes are deemed to be aligned. Only when the Phase Alignment Feedback signal 41 has a positive edge, i.e. goes from low to high, are the lanes 0 and N determined to be aligned.

For example: the setup time on the D-flip-flop 7 is defined as Tₛᵤ and the hold time for the D-flip-flop 7 is defined as Tₕ.

Let the time when the positive edge of the pulse occurs on Lane 0 be called T₀. For the phase alignment to be detected (0 is latched for the first time) the positive edge of Lane N (time T_{N}) must have the following relation.

T₀−Tₛᵤ<T_{N}<T₀+1UI+Tₕ

It can be seen that if T_{N} falls within the above criteria the phase of both the signals on lanes 0 and N is matched to be within:

1UI+Tₛᵤ+Tₕ.

Once the skew of the cross point switch 4 (FIG. 1) and the residual skew of the PCB board 1 are added the alignment of the lanes at the output of the cross point switch 4 is:

1UI+Tₛᵤ+Tₕ+XP_{DELAY}+RS

Where XP_{DELAY} is the port to port skew of the cross point switch 4, which is ±120 ps, (˜1UI at 3.125 Gbps) and RS is the residual skew on the PCB board 1, which is ˜0.5 UI.

We claim:

1. A method for de-skewing a plurality of parallel lanes in a parallel data transmission system, comprising the steps of:
a) selecting a first of the parallel lanes as a reference lane;
b) transmitting a test signal on the reference lane and on a second of the parallel lanes;
c) determining whether the test signal on the second of the parallel lanes is substantially in phase with the test signal on the reference lane;
d) if the test signal on the second of the parallel lanes is not in phase within the predetermined interval with the test signal on the reference lane, then determining an amount of phase adjustment required to bring the phase of the test signal on the second parallel lane substantially in phase within the predetermined interval with the test signal on the reference lane;
e) repeating steps b) to d) for all of the parallel lanes;
f) transmitting data signals over the plurality of parallel lanes, wherein the phase of each of the parallel lanes is individually adjusted in accordance with the amount of phase adjustment required to bring the phase of the test signal on the respective parallel lane substantially in phase within the predetermined interval with the test signal on the reference lane.

2. The method according to claim 1, wherein the predetermined interval is three or less universal intervals.

3. The method according to claim 1, further comprising shifting the test signal on the reference lane ahead by a plurality of bits to ensure that data on all the other lanes is now behind the data on the reference lane.

4. The method according to claim 3, wherein the test signal has a period four times greater than a predetermined maximum skew value to be compensated.

5. The method according to claim 3, wherein the test signal comprises at least a 256 bit, 50% duty cycle, clock pattern with at least 128 1’s and 128 0's.

6. The method according to claim 3, wherein the test signal on the reference lane is shifted ahead at least sixty-four bits with respect to all the other lanes.

7. The method according to claim 1, wherein step e) includes consecutively selecting and sending one of the test signals from the parallel lanes utilizing a switch to a phase comparator with the test signal on the reference lane.

8. The method according to claim 1, wherein step c) includes sending the selected signal from one of the parallel lanes into an input of a D flip-flop, whereby when edges of the test signals in the reference and selected lanes are aligned, the output of the D flip-flop transitions from a 1 to a 0, generating a Phase Alignment Feedback signal.

9. A lane skew alignment device for receiving a plurality of parallel multi-bit signals on a plurality of multi-bit lanes from an SFI encoder and for adjusting a phase of each of a plurality of parallel multi-bit signals for input to a SERDES, whereby all of the multi-bit signals are substantially in phase within a predetermined interval, comprising:
a control interface for selecting a first of the multi-bit parallel lanes as a reference lane, and for consecutively selecting remaining multi-bit parallel lanes for comparison thereto;
a pattern generator for transmitting a test signal on the reference lane and on the selected parallel lane;
a phase comparator for determining whether the test signal on the selected parallel lane is substantially in phase with the test signal on the reference lane; and
a lane shifter for shifting the selected parallel lane until the test signal on the selected parallel lane is substantially in phase with the test signal on the reference lane to determine an amount of phase adjustment required to bring the phase of the test signal on each of the parallel lanes substantially in phase within the predetermined interval with the test signal on the reference lane;
whereby the control interface adjusts data input to each lane until all the lanes are bit aligned within the predetermined interval at the output of the SERDES.

10. The device according to claim 9, wherein the control interface includes a switch for directing one of the multi-bit lanes at a time to the phase comparator.

11. The device according to claim 9, wherein the phase comparator comprises a D flip flop;
wherein the test signal on the reference lane forms a clock input signal, and the test signal on the selected parallel lane forms a comparison input signal, whereby when the clock input signal and the comparison input signal are substantially in phase within the predetermined interval, a feedback output signal is sent to the control interface.

12. The device according to claim 9, wherein pattern generator shifts the test signal on the reference lane ahead by a plurality of bits to ensure that data on all the other lanes is now behind the data on the reference lane.

13. The device according to claim 9, wherein the predetermined interval is three or less universal intervals.

14. The device according to claim 9, wherein the test signal has a period four times greater than a predetermined maximum skew value to be compensated.

15. The device according to claim 9, wherein the test signal comprises at least a 256 bit, 50% duty cycle, clock pattern with at least 128 1's and 128 0's.

16. The device according to claim 9, wherein the test signal on the reference lane is shifted ahead at least sixty-four bits with respect to all the other lanes.
